(19) United States
(12) Patent Application Publication
(10) Pub. No.: US 2012/0134487 A1
(43) Pub. Date: May 31, 2012

(54) PREDICTED PERCENT SERVICE LEVEL

(75) Inventors: Andrew D. Flockhart, Thornton, CO (US); Robert C. Steiner, Broomfield, CO (US)

(73) Assignee: AVAYA INC., Basking Ridge, NJ (US)

(21) Appl. No.: 12/955,676

(22) Filed: Nov. 29, 2010

(51) Int. Cl. H04M 3/00

(52) U.S. Cl. 379/265.12

(57) ABSTRACT

A contact center is described along with various methods and mechanisms for administering the same. The contact center proposed herein provides the ability to calculate short-term predictor metrics for achieving particular percent service level objectives in a plurality of skills, determine an optimal skill based on the comparison of short-term predictor metrics, and assign an agent to the optimal skill to increase the contact center's overall operational efficiency and performance.

### FIELD OF THE DISCLOSURE

The present disclosure is generally directed toward communications and more specifically toward contact centers.

### BACKGROUND

One of the primary metrics used in contact center is percent service level (% SL). Contact centers set % SL goals such as “80% in 30 seconds” for each contact type. This means that during a given time interval the objective is to answer a minimum of 80% of the inbound contacts of this type within 30 seconds or less.

When % SL is used as the primary objective for each skill in the contact center, it can be used to determine the type of contact that agents should service when they become available for new work.

Comparing the current percent service level (C % SL) with the target percent service level (T % SL) gives an indication of whether or not the objective for a given contact type is currently being met, where C % SL=(# answered within the service time objective/total number answered)*100.

When an agent becomes available, the system (i.e., routing engine of the contact center) can compare C % SL against the T % SL for each of the contact types which he is able to service. The routing engine will then assign the agent a contact of the type that currently has the worst percent service level relative to its target.

This can be done either using the delta between the two: Delta=C % SL−T % SL or the ratio of the two: Ratio=C % SL/T % SL.

The contact type with the lowest delta or the lowest ratio is deemed to be in the worst state currently relative to its objective.

Assigning work in this way works well in most situations, but there are some outcomes which are not optimal.

One situation is where one or more of the contact types have very low volume. During a given interval there may be only a handful of contacts contributing to the % SL metrics. In this situation, failing to meet the service time objective of only one contact can significantly reduce the current % SL achieved and send it far below the target objective.

For example, an agent becomes available who can service work from skill A or B. Both skills have a target % SL objective of 75% in 30 seconds. A's % SL is currently 80% while B's is currently 77%. Given these metrics, a conventional contact routing engine would assign work from skill B since it is not currently doing as well as skill A relative to its target objective.

However, if skill A is low volume and skill B is high volume, then there may be issues. Consider, for example, that A has serviced 4 out of 5 contacts on time, while B has serviced 77 out of 100 contacts on time. This means that C % SL for skill A=(⅘)*100=80% and C % SL for skill B=( 77/100)*100=77%.

If the next contact from skill A, the low volume skill, is not serviced in 30 seconds, the current % SL will fall significantly from 80% to 66.7% and skill A could fail to meet its primary objective of 75% in 30 seconds for the current interval, where C % SL for skill A=( 4/6)*100=66.7%.

If the next contact from skill B, the high volume skill, is not serviced in 30 seconds, the current % SL will only fall from 77% to 76.2% and the primary objective of 75% in 30 seconds will still be met, where C % SL for skill B=( 77/101)*100=76.2%.

In situations such as these, conventional contact routing engines do not optimally allocate contacts to the agents.

### SUMMARY

It is with respect to the above issues and other problems that the embodiments presented herein were contemplated.

The proposal described herein is to implement a short-term predictor for % SL metrics which will consider the impact of not servicing a contact and determine the consequences if this contact should then fail to meet its service time objective.

This predictor is called “predicted percent service level (P % SL)”, where P % S=(# answered within the service time objective/(total number answered+1))*100.

In the example discussed above, P % SL for A would be 66.7% and for B would be 76.2%. More specifically, P % SL for skill A=( 4/6)*100=66.7% and P % SL for skill B=( 77/101)*100=76.2%.

In one implementation of the proposed solution, a contact from the skill with the lowest delta would be assigned, where delta=P % SL−T % SL.

In another variant, a contact from the skill with the lowest ratio would be assigned, where ratio=P % SL/T % SL.

When P % SL is used, if an agent should now become available, a contact from skill A would now be assigned instead of from skill B, as skill A is at greater risk of missing its objective. In this way, assignments would be made in order to optimize the number of times that % SL objectives are successfully met.

One variation on this theme is to incorporate information about contacts which are still in queue but are already behind their service time objectives.

In this situation, if the number of contacts in queue that are already behind their service time objectives is “X”, then P % SL=(# answered within the service time objective/(total number answered+X))*100.

In some embodiments, predicted percent service level can also be used to perform at least the following: (i) determine the “Advocate State” of a skill and (ii) activate and deactivate reserve agents. “Advocate State” refers to a predicted future state of a contact or contact center queue and is discussed in further detail in U.S. Patent Publication No. 2005/0071211, the entire disclosure of which is hereby incorporated herein by reference.

In accordance with at least some embodiments of the present disclosure, a method of operating a contact center is provided, which generally comprises:

receiving, at a server responsible for making contact routing decisions in the contact center, an indication that an agent of the contact center has become available to service a contact;

determining, at the server, that the agent is eligible to be assigned to a first queue having a first skill associated therewith and a second queue having a second skill associated therewith;

determining, for the first queue, a short-term predictor metric which considers the impact of a next contact in the first queue failing to meet its service time objective;

determining, for the second queue, a short-term predictor metric which considers the impact of a next contact in the second queue failing to meets its service time objective;

comparing the short-term predictor metric of the first queue with the short-term predictor metric of the second queue;

based on the comparison of the short-term predictor metrics of the first and second queues, determining that the first queue at least one of (i) has a greater risk as compared to the second queue of failing to meet its percent service level objective and (ii) has a greater risk as compared to the second queue of falling further behind meeting its percent service level objective; and

in response to determining that at least one of (i) and (ii) is true with respect to the first queue, assigning the agent to the first queue.

The phrases “at least one”, “one or more”, and “and/or” are open-ended expressions that are both conjunctive and disjunctive in operation. For example, each of the expressions “at least one of A, B and C”, “at least one of A, B, or C”, “one or more of A, B, and C”, “one or more of A, B, or C” and “A, B, and/or C” means A alone, B alone, C alone, A and B together, A and C together, B and C together, or A, B and C together.

The term “a” or “an” entity refers to one or more of that entity. As such, the terms “a” (or “an”), “one or more” and “at least one” can be used interchangeably herein. It is also to be noted that the terms “comprising”, “including”, and “having” can be used interchangeably.

The term “automatic” and variations thereof, as used herein, refers to any process or operation done without material human input when the process or operation is performed. However, a process or operation can be automatic, even though performance of the process or operation uses material or immaterial human input, if the input is received before performance of the process or operation. Human input is deemed to be material if such input influences how the process or operation will be performed. Human input that consents to the performance of the process or operation is not deemed to be “material”.

The term “computer-readable medium” as used herein refers to any tangible storage that participates in providing instructions to a processor for execution. Such a medium may take many forms, including but not limited to, non-volatile media, volatile media, and transmission media. Non-volatile media includes, for example, NVRAM, or magnetic or optical disks. Volatile media includes dynamic memory, such as main memory. Common forms of computer-readable media include, for example, a floppy disk, a flexible disk, hard disk, magnetic tape, or any other magnetic medium, magneto-optical medium, a CD-ROM, any other optical medium, punch cards, paper tape, any other physical medium with patterns of holes, a RAM, a PROM, and EPROM, a FLASH-EPROM, a solid state medium like a memory card, any other memory chip or cartridge, or any other medium from which a computer can read. When the computer-readable media is configured as a database, it is to be understood that the database may be any type of database, such as relational, hierarchical, object-oriented, and/or the like. Accordingly, the disclosure is considered to include a tangible storage medium and prior art-recognized equivalents and successor media, in which the software implementations of the present disclosure are stored.

The terms “determine”, “calculate”, and “compute,” and variations thereof, as used herein, are used interchangeably and include any type of methodology, process, mathematical operation or technique.

The term “module” as used herein refers to any known or later developed hardware, software, firmware, artificial intelligence, fuzzy logic, or combination of hardware and software that is capable of performing the functionality associated with that element. Also, while the disclosure is described in terms of exemplary embodiments, it should be appreciated that individual aspects of the disclosure can be separately claimed.

### BRIEF DESCRIPTION OF THE DRAWINGS

The present disclosure is described in conjunction with the appended figures:

FIG. 1 is a block diagram of a communication system in accordance with embodiments of the present disclosure;

FIG. 2 is a block diagram depicting a server in accordance with embodiments of the present disclosure;

FIG. 3 is a block diagram depicting a data structure used in accordance with embodiments of the present disclosure;

FIG. 4 is a flow diagram depicting a contact routing method in accordance with embodiments of the present disclosure; and

FIG. 5 is a flow diagram depicting a predictor metric calculation method in accordance with embodiments of the present disclosure.

### DETAILED DESCRIPTION

The ensuing description provides embodiments only, and is not intended to limit the scope, applicability, or configuration of the claims. Rather, the ensuing description will provide those skilled in the art with an enabling description for implementing the embodiments. It being understood that various changes may be made in the function and arrangement of elements without departing from the spirit and scope of the appended claims.

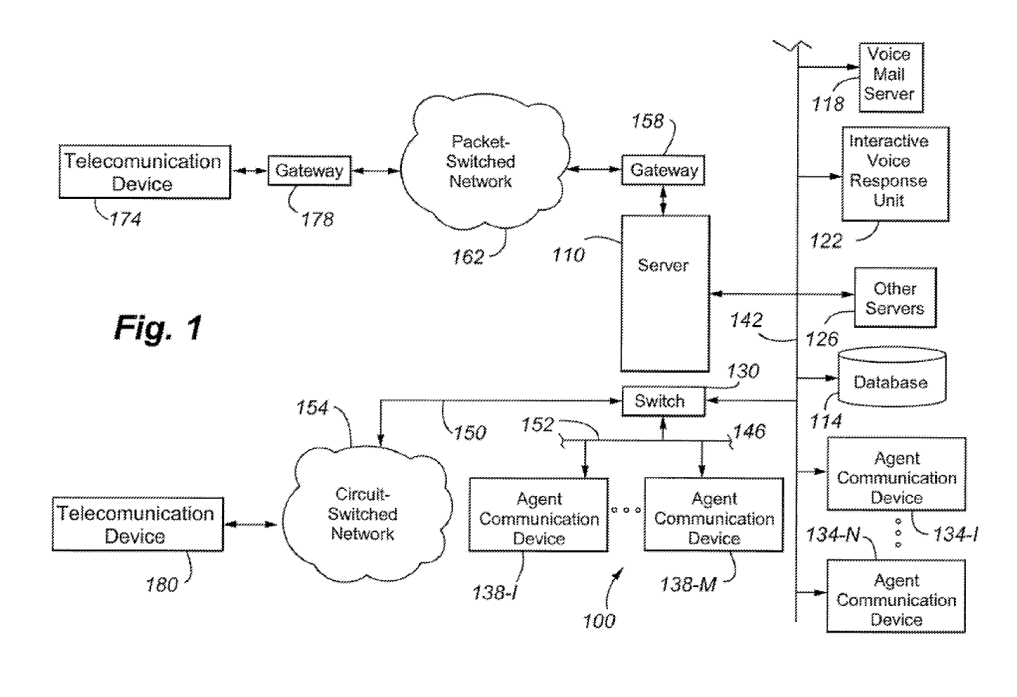

FIG. 1 shows an illustrative embodiment of the present disclosure. In one embodiment, a contact center 100 comprises a central server 110, a set of data stores or databases 114 containing contact or customer related information and other information that can enhance the value and efficiency of the contact processing, and a plurality of servers, namely a voice mail server 118, an Interactive Voice Response unit or IVR 122, and other servers 126, a switch 130, a plurality of working agents operating packet-switched (first) communication devices 134-1 to N (such as computer work stations or personal computers), and/or circuit-switched (second) communication devices 138-1 to M, all interconnected by a local area network LAN (or wide area network WAN) 142. The servers can be connected via optional communication lines 146 to the switch 130. As will be appreciated, the other servers 126 can also include a scanner (which is normally not connected to the switch 130 or Web server), VoIP software, video call software, voice messaging software, an IP voice server, a fax server, a web server, an email server, and the like. The switch 130 is connected via a plurality of trunks 150 to the Public Switch Telephone Network or PSTN 154 and via link(s) 152 to the second communication devices 138-1 to M. A gateway 158 is positioned between the server 110 and the packet-switched network 162 to process communications passing between the server 110 and the network 162.

The term “switch” or “server” as used herein should be understood to include a PBX, an ACD, an enterprise switch, or other type of communications system switch or server, as well as other types of processor-based communication control devices such as media servers, computers, adjuncts, etc.

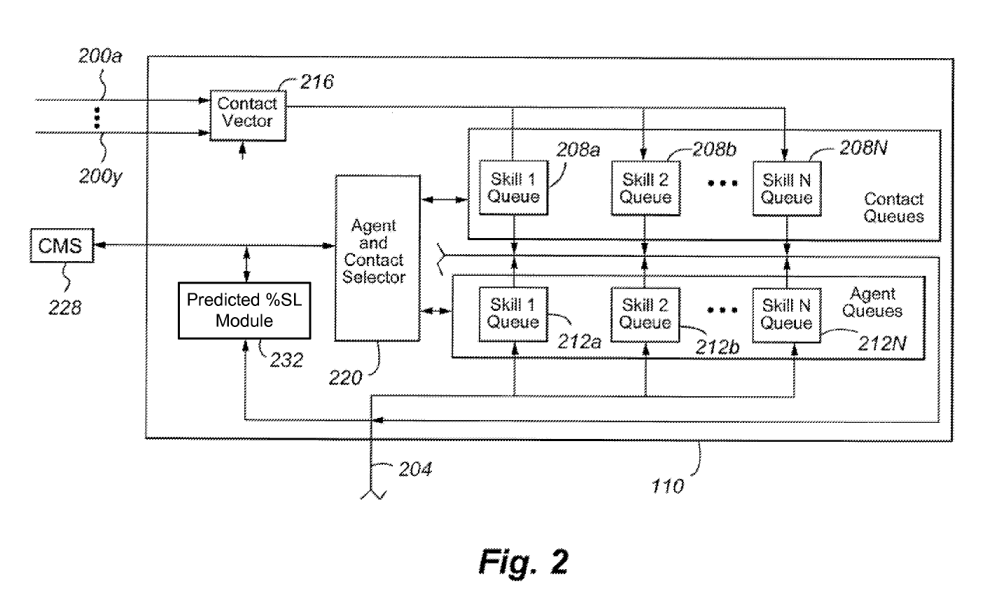

Referring to FIG. 2, one possible configuration of the server 110 is depicted. The server 110 is in communication with a plurality of customer communication lines 200a-y (which can be one or more trunks, phone lines, etc.) and agent communication line 204 (which can be a voice-and-data transmission line such as LAN 142 and/or a circuit switched voice line 140). The server 110 can include a Call Management System™ or CMS 228 that gathers call records and contact-center statistics for use in generating contact-center reports. CMS 228 and any other reporting system, such as a Basic Call Management System™, Operational Analyst™ or Customer Call Routingn or CCR™ will hereinafter be referred to jointly as CMS 228.

The switch 130 and/or server 110 can be any architecture for directing contacts to one or more communication devices. In some embodiments, the switch 130 may perform load-balancing functions by allocating incoming or outgoing contacts among a plurality of logically and/or geographically distinct contact centers. Illustratively, the switch and/or server can be a modified form of the subscriber-premises equipment disclosed in U.S. Pat. Nos. 6,192,122; 6,173,053; 6,163,607; 5,982,873; 5,905,793; 5,828,747; and 5,206,903, all of which are incorporated herein by this reference; Avaya Inc.'s Definity™ Private-Branch Exchange (PBX)-based ACD system; MultiVantage™ PBX, CRM Central 2000 Server™, Communication Manager™, S8300™ media server, SIP Enabled Services™, and/or Avaya Interaction Center™. Typically, the switch/server is a stored-program-controlled system that conventionally includes interfaces to external communication links, a communications switching fabric, service circuits (e.g., tone generators, announcement circuits, etc.), memory for storing control programs and data, and a processor (i.e., a computer) for executing the stored control programs to control the interfaces and the fabric and to provide automatic contact-distribution functionality. The switch and/or server typically include a network interface card (not shown) to provide services to the serviced communication devices. Other types of known switches and servers are well known in the art and therefore not described in detail herein.

As can be seen in FIG. 2, included among the data stored in the server 110 is a set of contact queues 208a-N and a separate set of agent queues 212a-N. Each contact queue 208a-N corresponds to a different set of agent queues, as does each agent queue 212a-N. Conventionally, contacts are prioritized and either are enqueued in individual ones of the contact queues 208a-N in their order of priority or are enqueued in different ones of a plurality of contact queues that correspond to a different priority. Likewise, each agent's queues are prioritized according to his or her level of expertise in that queue, and either agents are enqueued in individual ones of agent queues 212a-N in their order of expertise level or are enqueued in different ones of a plurality of agent queues 212a-N that correspond to a queue and each one of which corresponds to a different expertise level. Included among the control programs in the server 110 is a contact vector 216. Contacts incoming to the contact center are assigned by contact vector 216 to different contact queues 208a-N based upon a number of predetermined criteria, including customer identity, customer needs, contact center needs, current contact center queue lengths, customer value, and the agent skill that is required for the proper handling of the contact. Agents who are available for handling contacts are assigned to agent queues 212a-N based upon the skills that they possess. An agent may have multiple skills, and hence may be assigned to multiple agent queues 212a-N simultaneously. Furthermore, an agent may have different levels of skill expertise (e.g., skill levels 1-N in one configuration or merely primary skill levels and secondary skill levels in another configuration), and hence may be assigned to different agent queues 212a-N at different expertise levels. In some embodiments, when an agent is available and capable of handling contacts from two or more skills queues 208a-N, the server 110 may invoke an agent and contact selector 220 along with a predicted percent service level (% SL) module 232 to determine which skill queue 212a-N the agent should be assigned to, thereby driving the type of contact which is assigned to the agent.

Call vectoring is described in DEFINITY Communications System Generic 3 Call Vectoring/Expert Agent Selection (EAS) Guide, AT&T publication no. 555-230-520 (Issue 3, Nov. 1993). Skills-based ACD is described in further detail in U.S. Pat. Nos. 6,173,053 and 5,206,903.

Referring back to FIG. 1, the gateway 158 can be Avaya Inc.'s, G700 Media Gateway™ and may be implemented as hardware such as via an adjunct processor (as shown) or as a chip in the server.

In some embodiments, the first communication devices 134-1, . . . 134-N are packet-switched and can include, for example, IP hardphones such as the Avaya Inc.'s, 4600 Series IP Phones™, IP softphones such as Avaya Inc.'s, IP Softphone™, Personal Digital Assistants or PDAs, Personal Computers or PCs, laptops, packet-based H.320 video phones and conferencing units, packet-based voice messaging and response units, packet-based traditional computer telephony adjuncts, peer-to-peer based communication devices, and any other communication device.

In some embodiments, the second communication devices 138-1, . . . 138-M are circuit-switched. Each of the communication devices 138-1, . . . 138-M corresponds to one of a set of internal extensions Ext1, . . . ExtM, respectively. These extensions are referred to herein as “internal” in that they are extensions within the premises that are directly serviced by the switch. More particularly, these extensions correspond to conventional communication device endpoints serviced by the switch/server, and the switch/server can direct incoming calls to and receive outgoing calls from these extensions in a conventional manner. The second communication devices can include, for example, wired and wireless telephones, PDAs, H.320 videophones and conferencing units, voice messaging and response units, traditional computer telephony adjuncts, and any other communication device.

It should be noted that the disclosure does not require any particular type of information transport medium between switch or server and first and second communication devices, i.e., the disclosure may be implemented with any desired type of transport medium as well as combinations of different types of transport channels.

The packet-switched network 162 can be any data and/or distributed processing network, such as the Internet. The network 162 typically includes proxies (not shown), registrars (not shown), and routers (not shown) for managing packet flows.

The packet-switched network 162 is in communication with an external first communication device 174 via a gateway 178, and the circuit-switched network 154 with an external second communication device 180. These communication devices are referred to as “external” in that they are not directly supported as communication device endpoints by the switch or server. The communication devices 174 and 180 are an example of devices more generally referred to herein as “external endpoints.”

In a preferred configuration, the server 110, network 162, and first communication devices 134 are Session Initiation Protocol or SIP compatible and can include interfaces for various other protocols such as the Lightweight Directory Access Protocol or LDAP, H.248, H.323, Simple Mail Transfer Protocol or SMTP, IMAP4, ISDN, E1/T1, and analog line or trunk.

It should be emphasized that the configuration of the switch, server, user communication devices, and other elements as shown in FIG. 1 is for purposes of illustration only and should not be construed as limiting the disclosure to any particular arrangement of elements.

As will be appreciated, the central server 110 is notified via LAN 142 of an incoming contact by the communications component (e.g., switch 130, fax server, email server, web server, and/or other server) receiving the incoming contact. The incoming contact is held by the receiving communications component until the server 110 forwards instructions to the component to forward or route the contact to a specific contact center resource, such as the IVR unit 122, the voice mail server 118, and/or first or second communication device 134, 138 associated with a selected agent. The server 110 distributes and connects these contacts to communication devices of available agents based on the predetermined criteria noted above. When the central server 110 forwards a voice contact to an agent, the central server 110 also forwards customer-related information from databases 114 to the agent's computer work station for previewing and/or viewing (such as by a pop-up display) to permit the agent to better serve the customer. The agents process the contacts sent to them by the central server 110.

According to at least one embodiment of the present disclosure, the predicted % SL module 232 is provided to assist the agent and contact selector 220 in making agent-to-contact and/or contact-to-agent routing decisions. The predicted % SL module 232 is stored either in the main memory or in a peripheral memory (e.g., disk, CD ROM, etc.) or some other computer-readable medium of the center 100. The predicted % SL module 232 analyzes skill queues 208a, 208b, 208N, 212a, 212b, 212N to determine a short-term predictor for % SL metrics associated with each skill. Specifically, for each contact queue 208a-N, the predicted % SL module 232 refers to a target percent service level value (T % SL) assigned to the contact queue 208a-N.

The predicted % SL module 232 further computes a predicted % SL value (P % SL) for each contact queue 208a-N. In some embodiments, the P % SL for a given queue is calculated according to P % SL=(# answered within the service time objective/(total number answered+1))*100. In some embodiments where the number of contacts in queue that are already behind their service time objective is “X”, the P % SL for a given queue is calculated according to P % SL=(# answered within the service time objective/(total number answered+X))*100.

Regardless of the manner in which P % SL is calculated, the predicted % SL module 232 may then utilize the calculated P % SL and the T % SL for a given contact queue 208a-N to determine a short-term predictor metric for that queue, which can be used to assign the agent to one of agent queues 212a-N and more specifically to assign an agent to a contact enqueued within a particular contact queue 208a-N. In some embodiments, the short-term predictor metric is used to assign the agent to a contact queue 208a-N that is most at risk of failing to meet its service time objective (T % SL) or is most at risk of falling further behind meeting its service time objective. Accordingly, the predicted % SL module 232 enables the server 110 to not only account for current % SL, but also consider the impact on current % SL of the next contact in a queue failing to meets its service time objective.

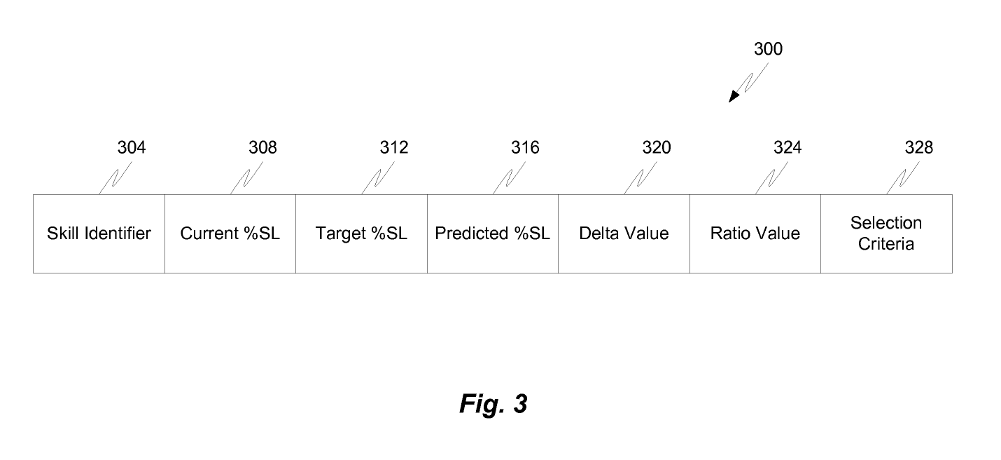

With reference now to FIG. 3, details of a data structure 300 which may be used to facilitate contact-routing decisions will be described in accordance with at least some embodiments of the present disclosure. The data structure 300 may be stored within memory of the server 110, the switch 130, the database 114, or any other memory device maintained within the contact center 100. The data structure 300 may be accessible to and maintained by the predicted % SL module 232 to facilitate intelligent contact routing decisions within a skill-based contact center 100.

The data structure 300 may include one or more data fields which enable the predicted % SL module 232 to provide the agent and contact selector 220 with necessary data to facilitate the contact routing decisions described herein. In some embodiments, the data fields may include a skill identifier field 304, a C % SL data field 308, a T % SL data field 312, a P % SL data field 316, a delta value data field 320, a ratio value data field 324, and a selection criteria data field 328.

The skill identifier data field 304 may comprise information which identifies the skill for which the short-term predictor metrics described herein are calculated. The skill identifier field 304 may comprise values which identify a particular contact queue 208a-N by skill type, a particular agent queue 212a-N by skill type, or the like. In some embodiments, a tabular implementation of the data structure 300 may comprise a plurality of rows, where each row corresponds to a different skill, contact queue 208, agent queue 212, or the like. Thus, a single skill identifier may be assigned to each row within the data structure 300. As can be appreciated, however, other forms of the data structure 300 such as pivot-tables, multi-dimensional arrays, balanced trees, linked lists, and the like may be utilized.

The C % SL field 308 may comprise a C % SL value or multiple C % SL values calculated for the corresponding skill, contact queue 208, agent queue 212, etc. In some embodiments, the C % SL is computed for a particular skill, contact queue 208, agent queue 212, or the like according to the following: C % SL=(# contacts answered within the service time objective/total number answered)*100.

Similarly, the T % SL field 312 may comprise a predetermined T % SL value or multiple T % SL values for a corresponding skill, contact queue 208, agent queue 212, etc. The T % SL corresponds to a predetermined target percent service level that is desired to be achieved for the skill.

The P % SL field 316 may comprise a calculated P % SL value or multiple P % SL values for a corresponding skill, contact queue 208, agent queue 212, etc. The P % SL values may be calculated in different manners depending upon whether the skill, contact queue 208, or agent queue 212 is currently on target (i.e., achieving its T % SL), behind target (i.e., failing to achieve its T % SL), or determined to be in a future risk state.

The delta value field 320 and ratio value field 324 may comprise short-term predictor metrics calculated based, at least in part, on the value contained in the corresponding P % SL field 316. In some embodiments, values for the delta value field 320 are calculated according to: delta=P % SL−T % SL. In some embodiments, values for the ratio value field 324 are calculated according to: ratio =P % SL/T % SL.

As can be appreciated, it may be possible to utilize different algorithms to calculate C % SL, T % SL, and/or P % SL. For example, it may not be necessary to multiple any calculated values by 100 to achieve an actual percentage value. Rather, the raw calculated ratios may be utilized to represent the C % SL, T % SL, and/or P % SL. As another example, calculations may be made which result in integer values of C % SL, T % SL, and/or P % SL. In some embodiments, the manner in which target objectives for a particular skill are determined may drive the algorithms used to calculate some or all values of C % SL, T % SL, and/or P % SL. This also means that the values for the delta value field 320 and ratio value field 324 may be calculated slightly differently, but such alternative calculation algorithms are considered to be within the scope of the present disclosure.

The selection criteria data field 328 may comprise information which determines which short-term predictor metric(s) should be used in contact routing decisions. In particular, the selection criteria data field 328 may comprise information defining whether values from the delta value field 320 or from the ratio value field 324 should be utilized in making a contact routing decision. If the selection criteria data field 328 identifies that the delta value field 320 is to be used for contact routing, then a contact from the corresponding contact queue 208 with the lowest delta value will be assigned to the next available agent. On the other hand, if the selection criteria data field 328 identifies the ratio value field 324 is to be used for contact routing, then a contact from the corresponding contact queue 208 with the lowest ratio value will be assigned to the next available agent. In some embodiments, the predicted % SL module 232 is capable of making these determinations and providing results of such determinations to the agent and contact selector 220, which is responsible for implementing the contact routing decision.

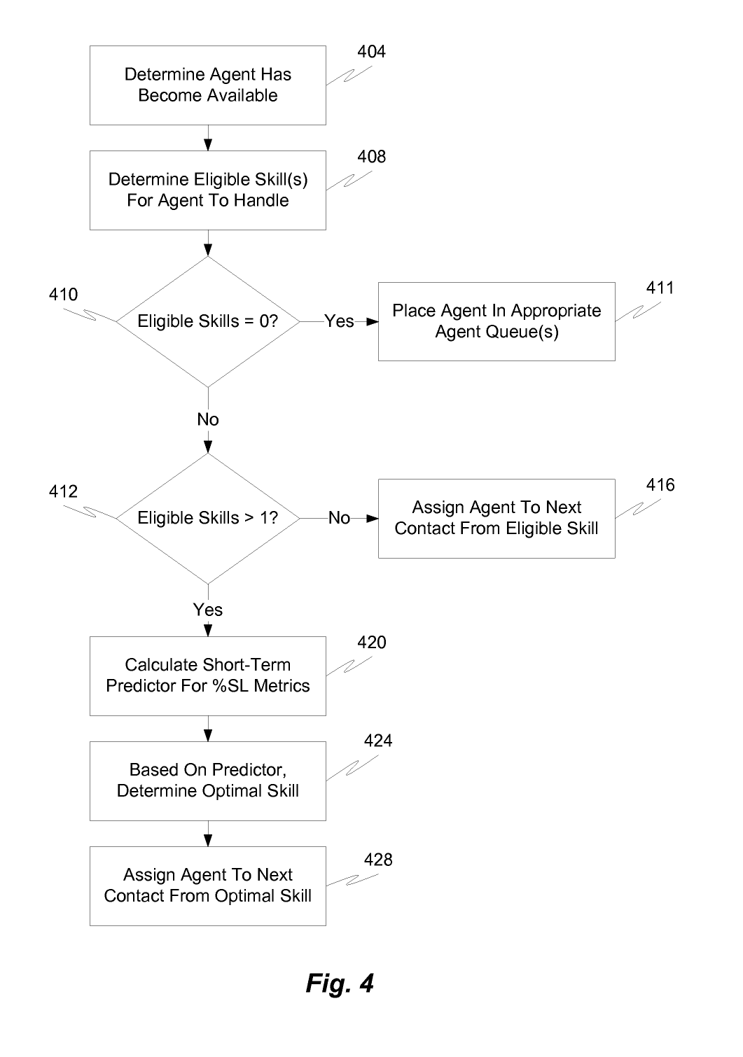

With reference now to FIG. 4, a contact routing method will be described in accordance with at least some embodiments of the present disclosure. The method begins when the agent and contact selector 220 determines that an agent has become available (step 404). This determination may be made by determining that an agent's status has changed from BUSY to AVAILABLE, or the like. Alternatively, the agent, upon becoming available (e.g., due to logging into the contact center 100 via the agent communication device or due to completing service of a contact) may transmit to the server 110 an indication that the agent is prepared to service another contact.

Upon determining that the agent has become available, the agent and contact selector 220 determines skills assigned to the agent (step 408). In particular, the agent and contact selector 220 determines which of the agent queues 212a-N the agent can be assigned to based on the qualifications and credentials associated with the agent. The initial decision made in this process is whether the agent is eligible to process any contacts that are waiting in a contact queue 208 (step 410). If there are no contacts available for processing in any of the agent's eligible skills, then the agent is placed in one or more agent queues 212 according to the agent's determined skill set (step 411).

If, however, the query of step 410 is answered negatively, then the method proceeds by determining if the agent is qualified to handle more than one eligible skill (step 412). Specifically, the agent and contact selector 220 may determine whether the agent is eligible to be assigned to multiple agent queues 212a-N, thereby making the agent eligible to process contacts from multiple contact queues 208a-N.

If the query of step 412 is answered negatively and the agent is not eligible to process more than one type of contact, then the agent and contact selector 220 will proceed in a typical fashion and assign the agent to the only agent queue 212 for which the agent is eligible (step 416). The practical effect of this action is that the agent is assigned to the next contact in the contact queue 212 corresponding to the agent queue 208 to which the agent has been assigned. In this situation, there is no need to analyze and compare service objectives of multiple contact queues 212a-N; thus, there is no need to invoke the predicted % SL module 232.

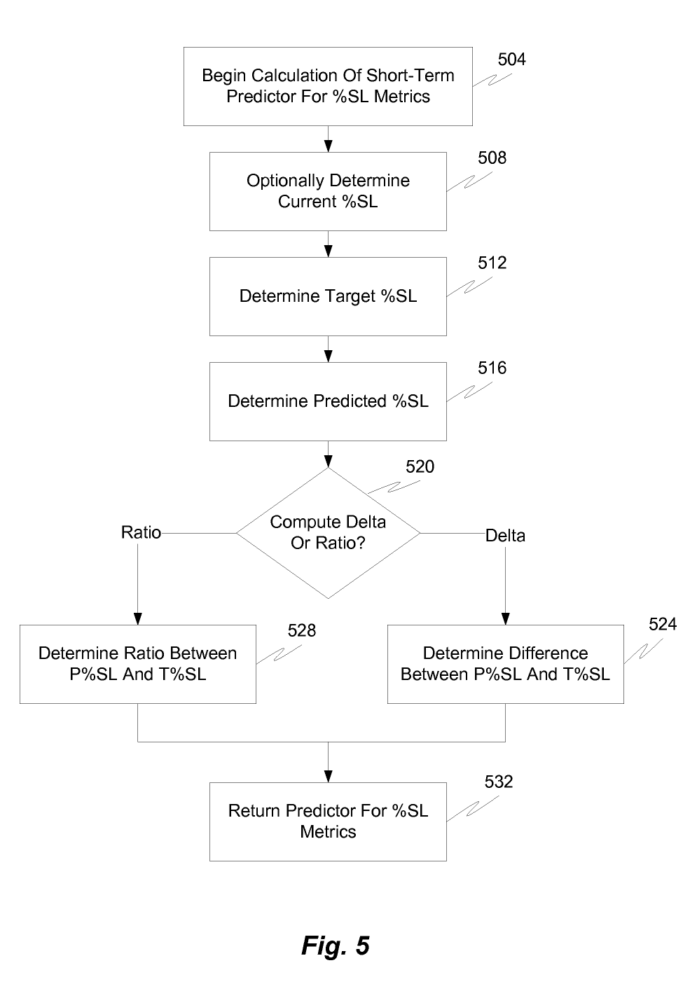

If, however, the query of step 412 is answered positively and the agent is eligible to process more than one type of contact, then the agent and contact selector 220 invokes the predicted % SL module 232 to calculate a short-term predictor metric for each of the agent's eligible skills (step 420). Details of the process for calculating the short-term predictor for % SL metrics will be described more fully with respect to FIG. 5.

For each of the agent's eligible skills, the predicted % SL module 232 calculates the appropriate short-term predictor for % SL metrics and compares the calculated values to determine an optimal skill for the agent (step 424). The optimal skill is optimal for the time at which the agent has just become available and the time at which the metrics were calculated. It should be appreciated that over time the various contact queues 208 will become more and less busy, thereby resulting in different queues 208 either failing to achieve their T % SL or becoming more likely to fall behind the T % SL. Accordingly, the optimal skill for an agent identified at a first point in time will likely be different from the optimal skill for the same agent identified at a second point in time. The optimal skill (i.e., contact queue 208 which the agent is eligible to process a contact from and which is in most need of having an agent assigned thereto) will vary over time and according to the current state of the contact center 100.

The method then continues with the predicted % SL module 232 providing an identification of the optimal skill to the agent and contact selector 220. The agent and contact selector 220 utilizes the information received from the predicted % SL module 232 and assigns the agent to the agent queue 212 corresponding to the optimal skill (step 428). This means that the agent and contact selector 220 only assigns the agent to one of the agent queues 212a-N, even though the agent is eligible to be assigned to multiple agent queues 212a-N. This helps ensure that the contact queue 208 in most need of having the agent assigned thereto actually has an agent assigned thereto. This helps to minimize the frequency with which target service level objectives are not met, thereby increasing call center 100 efficiency and customer satisfaction.

With reference now to FIG. 5, further details of calculating a short-term predictor metric for one or more skills, contact queues 208, and/or agent queues 212 will be described in accordance with at least some embodiments of the present disclosure. The method is initiated when the agent and contact selector 220 invokes the predicted % SL module 232 to begin a short-term predictor calculation routine (step 504). The method continues with the predicted % SL module 232 optionally determining C % SL for each of the agent's eligible skills (step 508). The reason that this step is optional is that C % SL is not normally necessary to compute the desire short-term predictor metric, but it may be a useful value for making other contact routing and re-routing decisions.

Thereafter, the predicted % SL module 232 determines a T % SL for each of the agent's eligible skills (step 512). The T % SL for a given skill (i.e., contact queue 208) may be a value reflecting percent service level goals over a predetermined period of time. In some embodiments, the T % SL is a value representing a particular minimum number or percentage of contacts that are desired to be serviced or answered within a predetermined amount of time. When the T % SL is determined as described above, the C % SL is a value representing the actual number or percentage of contacts that are serviced or answered within the same predetermined amount of time that was used to calculate T % SL.

The method continues with the predicted % SL module 232 determining a P % SL value for each of the agent's eligible skills (step 516). In some embodiments, the P % SL value is calculated by determining the number of contacts which were answered within the same predetermined amount of time that was used to calculate T % SL and dividing that number by the total number of contacts which were answered plus 1. This value may then be multiplied by 100 to obtain a percentage value.

Alternatively, if X number of contacts in a contact queue 208 are already behind their service time objective (i.e., have been waiting in a contact queue 208 longer than a predetermined service goal time for that contact queue 208), then P % SL may be calculated by determining the number of contacts which were answered within the same predetermined amount of time that was used to calculate T % SL and dividing that number by the total number of contacts which were answered plus X. Like the other proposed method of calculating P % SL, this determined value may or may not be multiplied to 100 to obtain a percentage value. In still another alternative, an X+1 number of contacts may be considered, where X is the number of contacts in a contact queue 208 that are already behind their service time objective.

Once the desired P % SL value has been obtained, the method continues with the predicted % SL module 232 determining whether the selection criteria corresponds to a delta value or a ratio value (step 520). In some embodiments, data from the selection criteria field 328 may be obtained from the data structure 300 to answer the query of step 520.

If a delta value is to be used as the selection criteria, then the predicted % SL module 232 calculates the delta value for each of the agent's eligible skills (step 524). If a ratio value is to be used as the selection criteria, then the predicted % SL module 232 calculates the ratio value for each of the agent's eligible skills (step 528). Regardless of whether delta values or ratio values are used, the method continues with the predicted % SL module 232 providing the short-term predictor metrics for each of the agent's eligible skills (step 532). In some embodiments, the predicted % SL module 232 provides the calculated values to the agent and contact selector 220, which compares the appropriate values and determines an optimal skill for the agent. Alternatively, the predicted % SL module 232 may perform the necessary comparison of short-term predictor metrics and provide the results of the comparison to the agent and contact selector 220.

In the foregoing description, for the purposes of illustration, methods were described in a particular order. It should be appreciated that in alternate embodiments, the methods may be performed in a different order than that described. It should also be appreciated that the methods described above may be performed by hardware components or may be embodied in sequences of machine-executable instructions, which may be used to cause a machine, such as a general-purpose or special-purpose processor (GPU or CPU) or logic circuits programmed with the instructions to perform the methods (FPGA). These machine-executable instructions may be stored on one or more machine readable mediums, such as CD-ROMs or other type of optical disks, floppy diskettes, ROMs, RAMs, EPROMs, EEPROMs, magnetic or optical cards, flash memory, or other types of machine-readable mediums suitable for storing electronic instructions. Alternatively, the methods may be performed by a combination of hardware and software.

Specific details were given in the description to provide a thorough understanding of the embodiments. However, it will be understood by one of ordinary skill in the art that the embodiments may be practiced without these specific details. For example, circuits may be shown in block diagrams in order not to obscure the embodiments in unnecessary detail. In other instances, well-known circuits, processes, algorithms, structures, and techniques may be shown without unnecessary detail in order to avoid obscuring the embodiments.

Also, it is noted that the embodiments were described as a process which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed, but could have additional steps not included in the figure. A process may correspond to a method, a function, a procedure, a subroutine, a subprogram, etc. When a process corresponds to a function, its termination corresponds to a return of the function to the calling function or the main function.

Furthermore, embodiments may be implemented by hardware, software, firmware, middleware, microcode, hardware description languages, or any combination thereof. When implemented in software, firmware, middleware or microcode, the program code or code segments to perform the necessary tasks may be stored in a machine readable medium such as storage medium. A processor(s) may perform the necessary tasks. A code segment may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, etc.

While illustrative embodiments of the disclosure have been described in detail herein, it is to be understood that the inventive concepts may be otherwise variously embodied and employed, and that the appended claims are intended to be construed to include such variations, except as limited by the prior art.

What is claimed is:

1. A method of operating a contact center, comprising:
receiving, at a server responsible for making contact routing decisions in the contact center, an indication that an agent of the contact center has become available to service a contact;
determining, at the server, that the agent is eligible to be assigned to a first queue having a first skill associated therewith and a second queue having a second skill associated therewith;
determining, for the first queue, a short-term predictor metric which considers the impact of a next contact in the first queue failing to meet its service time objective;
determining, for the second queue, a short-term predictor metric which considers the impact of a next contact in the second queue failing to meet its service time objective;
comparing the short-term predictor metric of the first queue with the short-term predictor metric of the second queue;
based on the comparison of the short-term predictor metrics of the first and second queues, determining that the first queue at least one of (i) has a greater risk as compared to the second queue of failing to meet its percent service level objective and (ii) has a greater risk as compared to the second queue of falling further behind meeting its percent service level objective; and
in response to determining that at least one of (i) and (ii) is true with respect to the first queue, assigning the agent to the first queue.

2. The method of claim 1, wherein the agent is not assigned to the second queue even though the agent is qualified to process contacts from the second queue.

3. The method of claim 2, further comprising:
routing a contact from the first queue to a communication device operated by the agent.

4. The method of claim 1, wherein the short-term predictor metrics of the first and second queues are determined, at least in part, by calculating a predicted percent service level value.

5. The method of claim 4, wherein neither the first nor the second queue are currently failing to meet their respective target percent service level objective, wherein (i) is true, wherein the predicted percent service level value for the first queue is calculated by dividing a number of contacts answered in the first queue within the service time objective by the sum of one and a total number of contacts answered in the first queue, and wherein the predicted percent service level value for the second queue is calculated by dividing a number of contacts answered in the second queue within the service time objective by the sum of one and a total number of contacts answered in the second queue.

6. The method of claim 4, wherein the first queue is currently failing to meet its target service time objective by X contacts, wherein the second queue is currently not failing to meet its respective target service time objective, wherein the predicted percent service level value for the first queue is calculated by dividing a number of contacts answered in the first queue within the service time objective by the sum of X and a total number of contacts answered in the first queue, and wherein the predicted percent service level value for the second queue is calculated by dividing a number of contacts answered in the second queue within the service time objective by the sum of one and a total number of contacts answered in the second queue.

7. The method of claim 4, wherein the first queue is currently failing to meet its target service time objective by X contacts, wherein the second queue is currently failing to meet its respective target service time objective by Y contacts, wherein the predicted percent service level value for the first queue is calculated by dividing a number of contacts answered in the first queue within the service time objective by the sum of X and a total number of contacts answered in the first queue, and wherein the predicted percent service level value for the second queue is calculated by dividing a number of contacts answered in the second queue within the service time objective by the sum of Y and a total number of contacts answered in the second queue.

8. The method of claim 4, wherein the short-term predictor metrics of the first and second queues are determined by calculating at least one of (i) a difference between the predicted percent service level value for the queue and a target percent service level value for the queue and (ii) a ratio between the predicted percent service level value for the queue and the target percent service level value for the queue.

9. The method of claim 1, wherein the short-term predictor metric of the first queue is less than the short-term predictor metric of the second queue even though the first queue is currently meeting its target service time objective but the second queue is not currently meeting its target service time objective.

10. A computer readable medium having stored thereon instructions that cause a computing system of a contact center to execute a method, the instructions comprising:
instructions configured to determine that an agent of the contact center has become available to service a contact;
instructions configured to determine that the agent is eligible to be assigned to a first queue having a first skill associated therewith and a second queue having a second skill associated therewith;
instructions configured to determine, for the first queue, a short-term predictor metric which considers the impact of a next contact in the first queue failing to meet its service time objective;
instructions configured to determine, for the second queue, a short-term predictor metric which considers the impact of a next contact in the second queue failing to meet its service time objective;
instructions configured to compare the short-term predictor metric of the first queue with the short-term predictor metric of the second queue;
instructions configured to determine, based on the comparison of the short-term predictor metrics of the first and second queues, that the first queue at least one of (i) has a greater risk as compared to the second queue of failing to meet its percent service level objective and (ii) has a greater risk as compared to the second queue of falling further behind meeting its percent service level objective; and
instructions configured to assign the agent to the first queue in response to determining that at least one of (i) and (ii) is true with respect to the first queue.

11. The computer readable medium of claim 10, wherein the agent is not assigned to the second queue even though the agent is qualified to process contacts from the second queue.

12. The computer readable medium of claim 10, wherein the short-term predictor metrics of the first and second queues are determined, at least in part, by calculating a predicted percent service level value.

13. The computer readable medium of claim 12, wherein neither the first nor the second queue are currently failing to meet their respective target percent service level objective, wherein (i) is true, wherein the predicted percent service level value for the first queue is calculated by dividing a number of contacts answered in the first queue within the service time objective by the sum of one and a total number of contacts answered in the first queue, and wherein the predicted percent service level value for the second queue is calculated by dividing a number of contacts answered in the second queue within the service time objective by the sum of one and a total number of contacts answered in the second queue.

14. The computer readable medium of claim 12, wherein the first queue is currently failing to meet its target service time objective by X contacts, wherein the second queue is currently not failing to meet its respective target service time objective, wherein the predicted percent service level value for the first queue is calculated by dividing a number of contacts answered in the first queue within the service time objective by the sum of X and a total number of contacts answered in the first queue, and wherein the predicted percent service level value for the second queue is calculated by dividing a number of contacts answered in the second queue within the service time objective by the sum of one and a total number of contacts answered in the second queue.

15. The computer readable medium of claim 12, wherein the first queue is currently failing to meet its target service time objective by X contacts, wherein the second queue is currently failing to meet its respective target service time objective by Y contacts, wherein the predicted percent service level value for the first queue is calculated by dividing a number of contacts answered in the first queue within the service time objective by the sum of X and a total number of contacts answered in the first queue, and wherein the predicted percent service level value for the second queue is calculated by dividing a number of contacts answered in the second queue within the service time objective by the sum of Y and a total number of contacts answered in the second queue.

16. The computer readable medium of claim 12, wherein the short-term predictor metrics of the first and second queues are determined by calculating at least one of (i) a difference between the predicted percent service level value for the queue and a target percent service level value for the queue and (ii) a ratio between the predicted percent service level value for the queue and the target percent service level value for the queue.

17. The computer readable medium of claim 10, wherein the short-term predictor metric of the first queue is less than the short-term predictor metric of the second queue even though the first queue is currently meeting its target service time objective but the second queue is not currently meeting its target service time objective.

18. A contact center, comprising:
a server including instructions contained in memory and a processor for executing the instructions contained in memory, the instructions of the server including:
instructions configured to determine that the agent is eligible to be assigned to a first queue having a first skill associated therewith and a second queue having a second skill associated therewith;
instructions configured to determine, for the first queue, a short-term predictor metric which considers the impact of a next contact in the first queue failing to meet its service time objective;
instructions configured to determine, for the second queue, a short-term predictor metric which considers the impact of a next contact in the second queue failing to meet its service time objective;
instructions configured to compare the short-term predictor metric of the first queue with the short-term predictor metric of the second queue;
instructions configured to determine, based on the comparison of the short-term predictor metrics of the first and second queues, that the first queue at least one of (i) has a greater risk as compared to the second queue of failing to meet its percent service level objective and (ii) has a greater risk as compared to the second queue of falling further behind meeting its percent service level objective; and
instructions configured to assign the agent to the first queue in response to determining that at least one of (i) and (ii) is true with respect to the first queue.

19. The contact center of claim 18, wherein the short-term predictor metric of the first queue is less than the short-term predictor metric of the second queue thereby causing at least one of (i) and (ii) to be true with respect to the first queue even though the first queue is currently meeting its target service time objective but the second queue is not currently meeting its target service time objective.

20. The contact center of claim 18, wherein the agent is assigned to the first queue even though a metric calculated for the first and second queues based on a current percent service level for the first and second queues, respectively, indicates that the agent should be assigned to the second queue.
